(19) United States
(12) Patent Application Publication
(10) Pub. No.: US 2016/0320017 A1
(43) Pub. Date: Nov. 3, 2016

(54) Light Beam Controlling Member and Light-Emitting Component

(71) Applicant: Lextar Electronics Corporation, Hsinchu (TW)

(72) Inventor: Min-Chen CHIU, Tainan City (TW)

(21) Appl. No.: 14/939,520

(22) Filed: Nov. 12, 2015

(30) Foreign Application Priority Data
May 1, 2015 (TW) 104114072

(51) Int. Cl. F21V 5/04; F21V 13/04; F21V 7/05

(52) U.S. Cl. CPC F21V 5/04; F21V 7/05; F21V 13/04; F21Y 2101/02

(57) ABSTRACT

A light beam controlling member covers an optical device, and the optical device emits light. The light beam controlling member has a body. The body has an optical axis, and the body has a bottom surface, a light-entering surface, and a light-exiting surface. The bottom surface is connected to the light-entering surface and the light-exiting surface. The light-exiting surface is located on an outer side of the body, and the light-entering surface is located on an inner side of the body. The light-entering surface defines a cavity, and the cavity accommodates the optical device. The light-entering surface is divided into a first light-entering region and a second light-entering region. The first light-entering region is a concave surface. The second light-entering region is connected to the first light-entering region and the bottom surface, and the second light-entering region is an inwardly inclined surface.

### RELATED APPLICATIONS

This application claims priority to Taiwanese Application Serial Number 104114072, filed May 1, 2015, which are herein incorporated by reference.

### BACKGROUND

1. Technical Field

The present disclosure relates to a light beam controlling member, and more particularly, to a light beam controlling member for adjusting a light pattern of a direct type backlight module.

2. Description of Related Art

Because light-emitting diodes (LEDs) has the advantages of high brightness, fast response, small size, low pollution, high reliability, being suitable for mass production, etc., there are more and more applications of LEDs in lighting or consumer electronics products. Currently, LEDs are widely applied as light sources of large-scale billboards, traffic lights, cell phones, scanners, fax machines, and lighting devices, etc. From the above applications, it can be known that the luminous efficiency and the brightness of LEDs get more and more attention, so that the research and development of high-brightness LEDs become an important topic on the solid-state lighting applications.

LEDs have replaced fluorescent and incandescent lamps in some applications, such as a light source of a scanner which demands high-speed response, a light source of a projection device, a backlight or a front light of a liquid crystal display, a light source of a car dashboard, a light source of a traffic light, light sources for general lighting devices, etc. Compared to conventional lamps, LEDs have significant advantages such as smaller size, longer operation life, low driving voltage/ current, high structural strength, no mercury pollution, and high luminous efficiency (energy saving), etc.

LEDs may also be used as a light source of a direct type backlight module of a liquid crystal display panel. In order to make the light pattern in line with the requirement of the liquid crystal display panel, a light beam controlling member such as a lens is often used to adjust the direction of the light emitted by the LEDs. However, if a LED emits light from its five surfaces (i.e., except the bottom surface, the side surfaces and the top surface of the LED all emit light), the side light leakage often occurs in the direct type backlight module, and thus the light emitted by the LEDs cannot be effectively used.

### SUMMARY

This disclosure provides a light beam controlling member to effectively enhance the brightness of a light-emitting component by disposing an inwardly inclined light entering region.

In one aspect of the disclosure, a light beam controlling member is provided. The light beam controlling member is configured to cover an optical component, and the optical component generates light. The light beam controlling member includes a body. The body has a symmetrical optical axis, and the body has a bottom surface, a light entering surface, and a light exiting surface. The bottom surface is connected to the light entering surface and the light exiting surface. The light exiting surface is located on an outer side of the body, and the light enter surface is on an inner side of the body. The light entering surface defines a cavity, and the cavity accommodates the light component. The light entering surface is divided into a first light entering region and a second light entering region. The first light entering region is a concave surface. The second light entering region is connected to the first light entering region and the bottom surface, and the second light entering region is an inwardly inclined surface.

In one or more embodiments, the symmetric optical axis intersects a virtual surface extending from the bottom surface of the body at a reference point. A first line connecting the reference point to any point of the light entering surface has a first length, and a first angle is formed between the first line and the symmetrical optical axis. The greater the first angle is, the smaller the first length is.

In one or more embodiments, the light exiting surface is convex, and the symmetric optical axis intersects a virtual surface extending from the bottom surface of the body at a reference point. A second line connecting the reference point to any point of the light exiting surface has a second length, and a second angle is formed between the second line and the symmetrical optical axis. The greater the second angle is, the greater the second length is.

In one or more embodiments, a third angle is formed between the second light entering region and the bottom surface, and the third angle is smaller than 90°.

In one or more embodiments, the third angle is in a range from about 40° to about 50°.

In one or more embodiments, the third angle is about 45°.

In one or more embodiments, the second light entering region is divided into a first light entering sub-region and a second light entering sub-region. The first light entering sub-region is a smooth surface, and the second light entering sub-region is a sandblasted matte structure.

In another aspect of the disclosure, a light-emitting component is provided. The light-emitting component includes a substrate, an optical component, and the light beam controlling member. The substrate has a top surface used as a reflective surface. The optical component is disposed on the substrate, and the optical component generates light. The light beam controlling member is disposed on the substrate.

In one or more embodiments, the top surface is a white paint reflective surface.

In one or more embodiments, the top surface is divided into a central part and a peripheral part. The optical component is disposed on the central part, and the bottom surface is at least partially disposed on the peripheral part. The central part is a white paint layer, and the peripheral part is a metal reflective surface.

By disposing the inwardly inclined second light entering region, the light emitted from the side surface of the optical component along the horizontal direction is refracted by the second light entering region to proceed obliquely downward, and then the light is refracted by the top surface of the substrate 200 to proceed obliquely upward and leave the light exiting surface approximately along the same direction, thus preventing the side light leakage, and effectively enhancing the brightness of the light-emitting component.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic perspective view of a light-emitting component according to one embodiment of this disclosure;

FIG. 2 is a schematic cross-sectional view viewed along line 2-2 of FIG. 1 according to one embodiment of this disclosure;

FIG. 3 is a schematic cross-sectional view viewed along line 2-2 of FIG. 1 according to another embodiment of this disclosure;

FIG. 4 is a schematic cross-sectional view viewed along line 2-2 of FIG. 1 according to another embodiment of this disclosure;

FIG. 5 is a schematic cross-sectional view viewed along line 2-2 of FIG. 1 according to another embodiment of this disclosure;

FIG. 6 is a schematic cross-sectional view viewed along line 2-2 of FIG. 1 according to another embodiment of this disclosure; and

FIG. 7 is a diagram showing the relationship of brightness to beam angle between the light-emitting component of one embodiment of this disclosure and a conventional light-emitting component.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

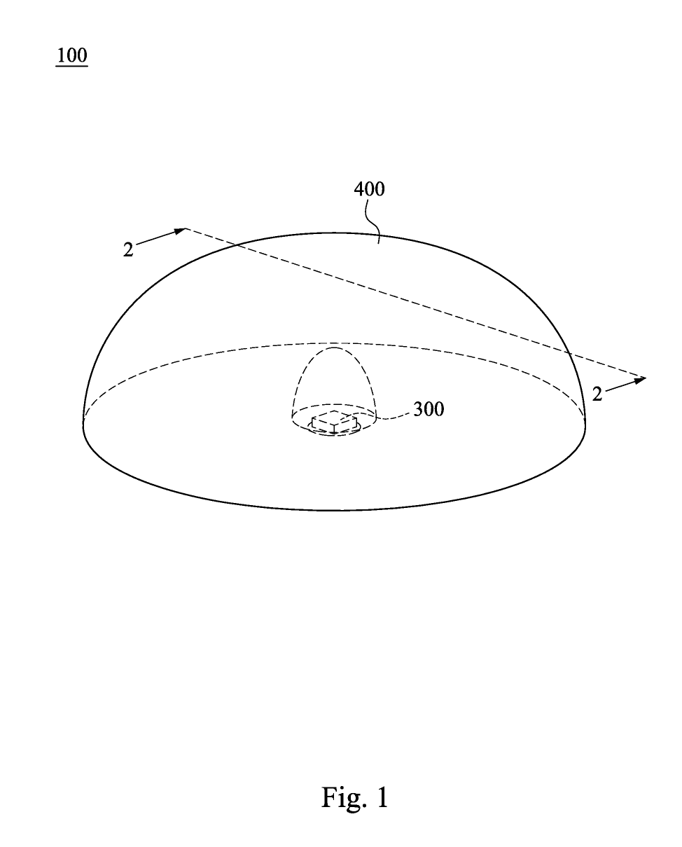

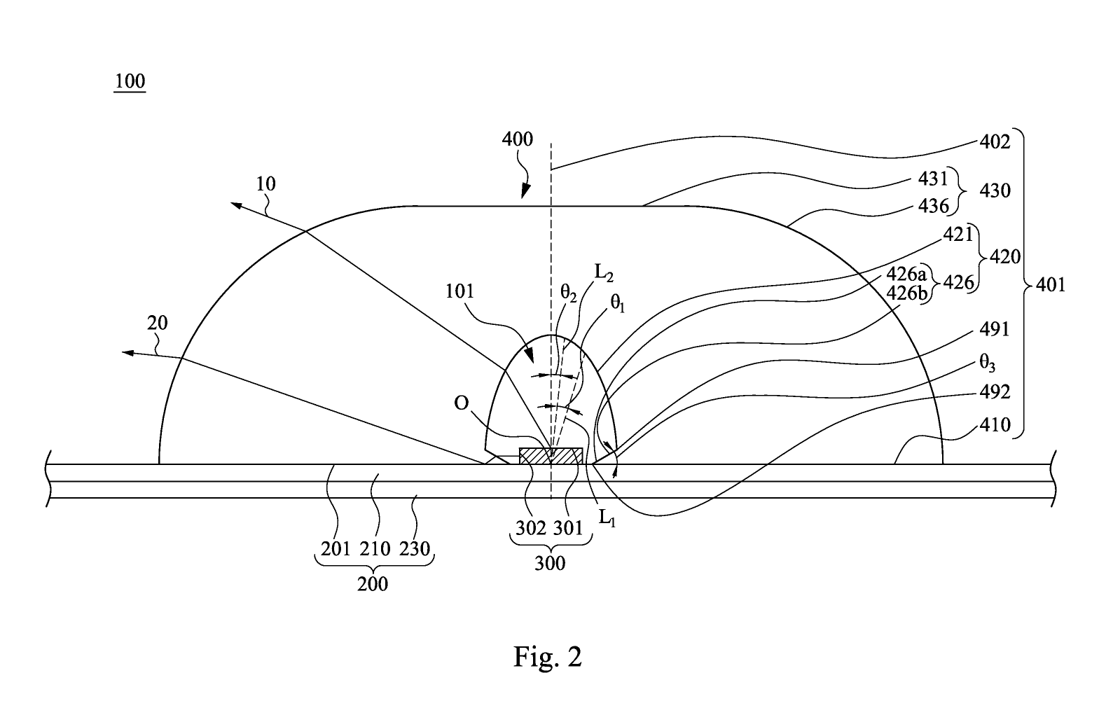

FIG. 1 is a schematic perspective view of a light-emitting component 100 according to one embodiment of this disclosure. FIG. 2 is a schematic cross-sectional view viewed along line 2-2 of FIG. 1 according to one embodiment of this disclosure. A light-emitting component 100 is provided, and the light-emitting component 100 is mainly used as a light source of a direct type backlight module.

As shown in FIG. 1 and FIG. 2, the light-emitting component 100 includes a substrate 200, an optical component 300, and a light beam controlling member 400. The substrate 200 has a top surface 201 used as a reflective surface. The optical component 300 is disposed on the substrate 200, and the optical component 300 generates light. The light beam controlling member 400 is disposed on the substrate 200 and covers the optical component 300.

Specifically, the optical component 300 may be a light-emitting diode (LED). More specifically, the optical component 300 may be a LED emitting light from its five surfaces (i.e., except the bottom surface, the side surfaces and the top surface of the LED emit light). Embodiments of this disclosure are not limited thereto. People having ordinary skill in the art can make proper modifications to the optical component 300 depending on actual applications.

The light beam controlling member 400 includes a body 401. The body 401 has a symmetrical optical axis 402, and the body 401 has a bottom surface 410, a light entering surface 420, and a light exiting surface 430. The bottom surface 410 is connected to the light entering surface 420 and the light exiting surface 430. The light exiting surface 430 is located on an outer side of the body 401, and the light enter surface 420 is located on an inner side of the body 401. The light entering surface 420 defines a cavity 101, and the cavity 101 accommodates the optical component 300. The light entering surface 420 is divided into a first light entering region 421 and a second light entering region 426. The first light entering region 421 is a concave surface. The second light entering region 426 is connected to the first light entering region 421 and the bottom surface 410, and the second light entering region 426 is an inwardly inclined surface.

Since the optical component 300 emits light from its five surfaces ((i.e., except the bottom surface, the side surfaces and the top surface of the optical component 300 emit light), the optical component 300 emits a light 20 along the horizontal direction from the side surface 302. In a conventional light-emitting component, since the light leaves the light exiting surface along the horizontal direction, the side light leakage occurs. In the light-emitting component 100, when the light 20 enters the second light entering region 426, the light 20 is refracted (the index of refraction of the body 401 is greater than the index of refraction of air) and proceeds obliquely downward, and then the light 20 proceeds to the top surface 201 of the substrate 200 and is reflected by the top surface 201. Therefore, the light 20 proceeds obliquely upward and leaves the light exiting surface 430 along approximately the same direction, such that the side light leakage is prevented and the brightness of the light-emitting component 100 is effectively enhanced.

Specifically, the body 401 is made of glass or plastic. Embodiments of this disclosure are not limited thereto. People having ordinary skill in the art can make proper modifications to the body 401 depending on actual applications.

In the embodiment, the bottom surface 410, the light entering surface 420, and the light exiting surface 430 are symmetrical to the symmetrical optical axis 402. Embodiments of this disclosure are not limited thereto. In other embodiments, the bottom surface 410, the light entering surface 420, and the light exiting surface 430 may not be symmetrical to the symmetrical optical axis 402, depending on actual needs.

Specifically, the minimum distance between the symmetrical optical axis 402 and the connection 491 between the second light entering region 426 and the first light entering region 421 (i.e. the top end of the second light entering region 426) is greater than the minimum distance between the symmetrical optical axis 402 and the connection 492 of the second light entering region 426 and the bottom surface 410 (i.e. the bottom end of the second light entering region 426). In other words, the connection 492 between the second light entering region 426 and the bottom surface 410 (i.e., the bottom end of the second light entering region 426) is closer to the optical component 300 than the connection 491 between the second light entering region 426 and the first light entering region 421 is (i.e., the top end of the second light entering region 426).

In the embodiment, the symmetric optical axis 402 intersects a virtual surface extending from the bottom surface 410 at a reference point O. A first line L₁ connecting the reference point O to any point of the light entering surface 420 has a first length, and the first line L₁ and the symmetrical optical axis 402 form a first angle θ₁. The greater the first angle θ₁ is, the smaller the first length is. The light exiting surface 430 is convex. A second line L₂ connecting the reference point O to any point of the light exiting surface 430 has a second length, and the second line L₂ and the symmetrical optical axis 402 form a second angle θ₂. The greater the second angle θ₂ is, The greater the second length is. Therefore, when light 10 emitted from a top surface 301 of the optical component 300 is refracted by the light entering surface 420 and the light exiting surface 430, the light 10 is refracted outwardly (i.e., the angle between the light 10 and the symmetrical optical axis 402 becomes greater). Then, instead of only proceeding upwardly, the light 10 emitted from the top surface 301 is refracted by the light beam controlling member 400 and thus evenly proceeds in different directions, such that the brightness of the light emitted by the light-emitting component 100 in different directions becomes more even. Therefore, if the light-emitting component 100 is used as the light source of the direct type backlight module, the light-emitting component 100 can function as a uniform light source of the liquid crystal display panel, so as to enhance display quality of the liquid crystal display panel. Embodiments of this disclosure are not limited thereto. People having ordinary skill in the art can make proper modifications to the light entering surface 420 and the light exiting surface 430 depending on actual applications.

Specifically, the light exiting surface 430 is divided into a first light exiting region 431 and a second light exiting region 436. The first light exiting region 431 is disposed directly above the optical component 300 or directly above the cavity 101. The second light exiting region 436 surrounds the first light exiting region 431 and is connected to the bottom surface 410. The first light exiting surface 431 is planar.

Specifically, the second light entering region 426 and the bottom surface 410 form a third angle θ₃, and the third angle θ₃ is smaller than 90°. More specifically, the third angle θ₃ is in a range from about 40° to about 50°, or the third angle θ₃ is about 45°. Embodiments of this disclosure are not limited thereto. People having ordinary skill in the art can make proper modifications to the second light entering region 426 depending on actual applications.

Specifically, the second light entering region 426 may be further divided into a first light entering sub-region 426a and a second light entering sub-region 426b. The first light entering sub-region 426a is a smooth surface, and the second light entering sub-region 426b is a sandblasted matte structure. In the embodiment, the first light entering sub-region 426a is the lower portion of the second light entering region 426, and the second light entering sub-region 426b is the upper portion of the second light entering region 426. Embodiments of this disclosure are not limited thereto. People having ordinary skill in the art can make proper modifications to the actual deposition position of the first light entering sub-region 426a and the second light entering sub-region 426b depending on actual needs (for example, light pattern design).

Specifically, the height of the top surface 301 of the optical component 300 is greater than the height of the connection 491 between the second light entering region 426 and the first light entering region 421 (i.e., the top end of the second light entering region 426). Embodiments of this disclosure are not limited thereto. People having ordinary skill in the art can make proper modifications to the optical component 300 and the second light entering region 426 depending on actual needs (for example, light pattern design).

Specifically, the substrate 200 may further include a first reflective layer 210 and a carrier 230. The first reflective layer 210 is disposed on the carrier 230. More specifically, the first reflective layer 210 may be a white paint reflective surface, so that the top surface 210 (i.e., the top surface 201 of the first reflective layer 210) may be a white paint reflective surface. Embodiments of this disclosure are not limited thereto. People having ordinary skill in the art can make proper modifications to the substrate 200 depending on actual applications.

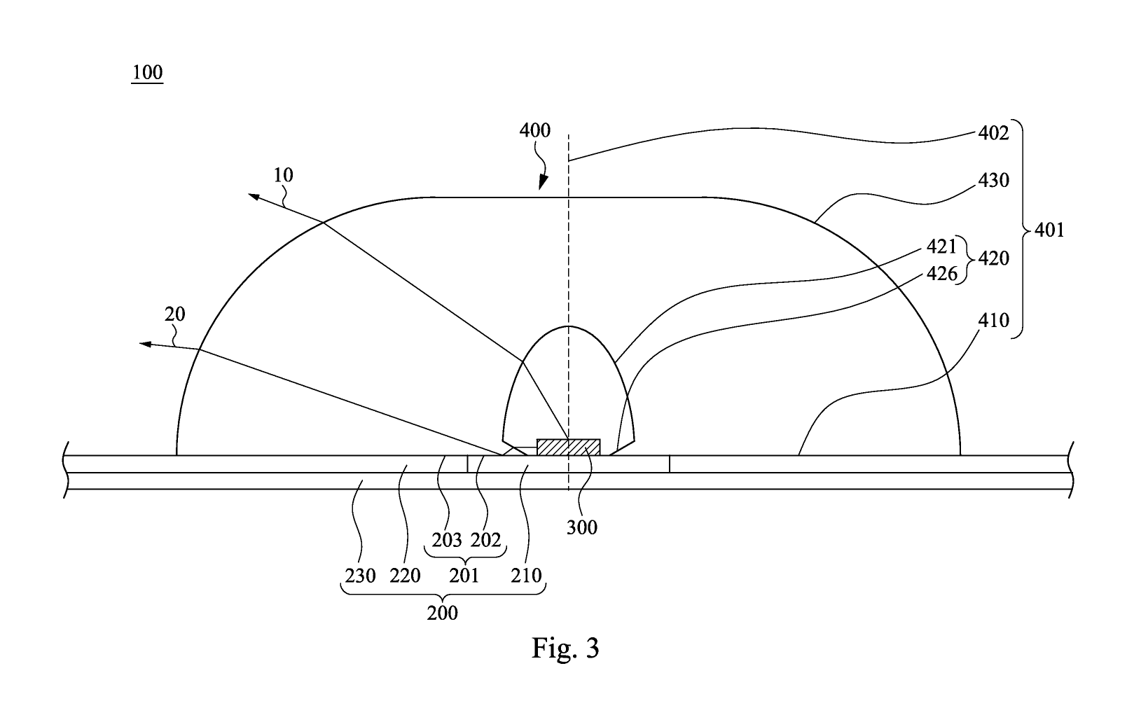

FIG. 3 is a schematic cross-sectional view viewed along line 2-2 of FIG. 1 according to another embodiment of this disclosure. As shown in FIG. 3, the light-emitting component 100 of this embodiment is similar to the light-emitting component 100 shown in FIG. 2, and the main difference therebetween is that the substrate 200 of the embodiment may further include a first reflective layer 210, a second reflective layer 220, and a carrier 230. The first reflective layer 210 and the second reflective layer 220 are disposed on the carrier 230, and the second reflective layer 220 surrounds the first reflective layer 210. The optical component 300 is disposed on the first reflective layer 210. The bottom surface 410 of the body 401 is at least partially disposed on the second reflective layer 220. Specifically, the first reflective layer 210 may be a white paint reflective surface, and the second reflective layer 220 may be a metal reflective surface. Because the optical component 300 is not in contact with the second reflective layer 220, an unnecessary electrical connection between the optical component 300 and other components is avoided.

In other words, the top surface 201 of the substrate 200 may be divided into a central part 202 (i.e., the top surface of the first reflective layer 210) and a peripheral part 203 (i.e., the top surface of the second reflective layer 220). The optical component 300 is disposed on the central part 202, and the bottom surface 410 of the body 401 is at least partially disposed on the peripheral part 203. The central part 202 is a white paint layer, and the peripheral part 203 is a metal reflective surface.

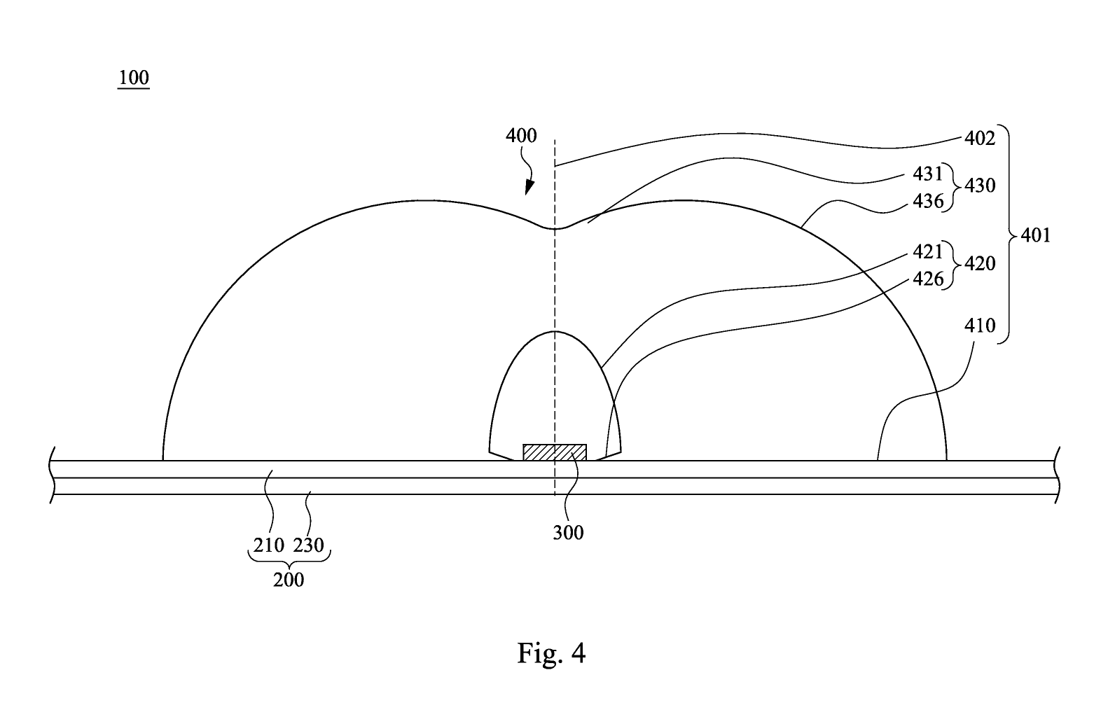

FIG. 4 is a schematic cross-sectional view viewed along line 2-2 of FIG. 1 according to another embodiment of this disclosure. As shown in FIG. 4, the light-emitting component 100 of this embodiment is similar to the light-emitting component 100 shown in FIG. 2, and the main difference therebetween is that the first light exiting region 431 of this embodiment is inwardly depressed.

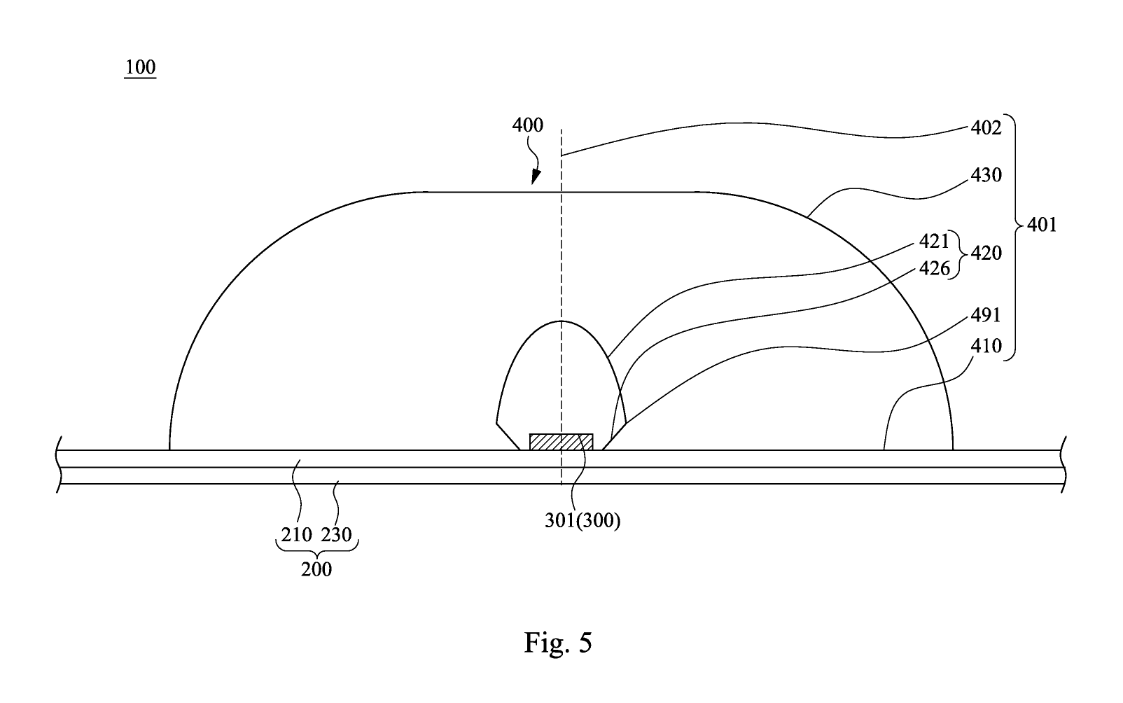

FIG. 5 is a schematic cross-sectional view viewed along line 2-2 of FIG. 1 according to another embodiment of this disclosure. As shown in FIG. 5, the light-emitting component 100 of this embodiment is similar to the light-emitting component 100 shown in FIG. 2, and the main difference therebetween is that the height of the top surface 301 of the optical component 300 is smaller than the height of the connection 491 between the second light entering region 426 and the first light entering region 421 (i.e., the top end of the second light entering region 426).

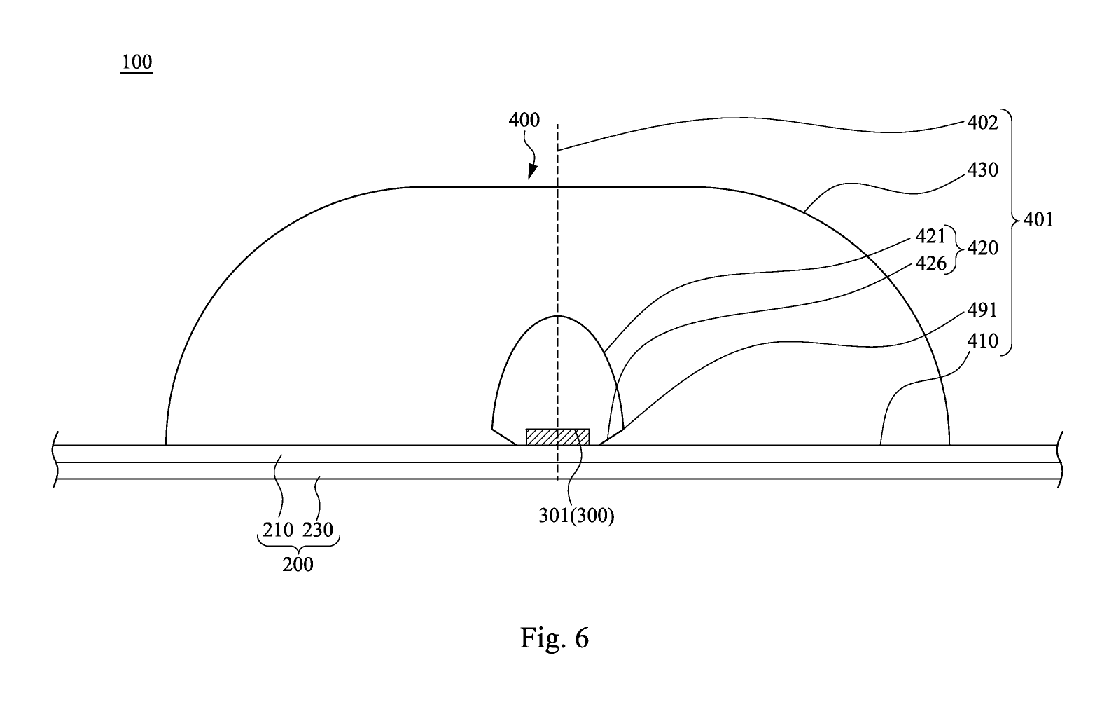

FIG. 6 is a schematic cross-sectional view viewed along line 2-2 of FIG. 1 according to another embodiment of this disclosure. As shown in FIG. 6, the light-emitting component 100 of this embodiment is similar to the light-emitting component 100 shown in FIG. 2, and the main difference therebetween is that the height of the top surface 301 of the optical component 300 is equal to the height of the connection 491 between the second light entering region 426 and the first light entering region 421 (i.e., the top end of the second light entering region 426).

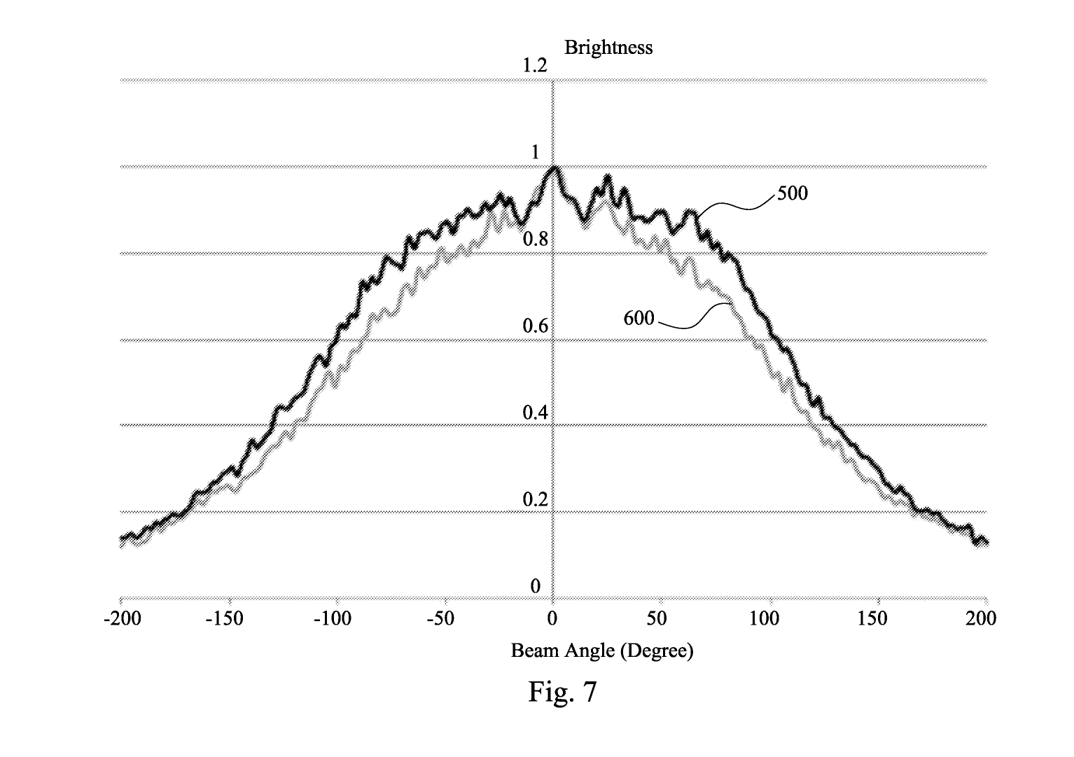

FIG. 7 is a diagram showing the relationship of brightness to beam angle between the light-emitting component 100 and a conventional light-emitting component. As shown in FIG. 7, a curve 500 represents the relationship between the brightness and the beam angle of the light-emitting component 100, and a curve 600 represents the relationship between the brightness and the beam angle of the conventional light-emitting component. Because the magnitude of the brightness is normalized, there is no unit on y axis, and the maximum brightness of the light-emitting component 100 and the conventional light-emitting component is 1. As shown in FIG. 7, compared to the conventional light-emitting component, the brightness of the light-emitting component 100 in different beam angles is greater than that of the conventional light-emitting component. Therefore, the second light entering region 426 (shown in FIG. 2) can indeed effectively enhance the brightness of the light-emitting component 100.

By disposing the inwardly inclined second light entering region 426, the light 20 along the horizontal direction emitted from the side surface 302 of the optical component 300 is refracted by the second light entering region 426 to proceed obliquely downward, and then the light 20 is refracted by the top surface 201 of the substrate 200 to proceed obliquely upward and leave the light exiting surface 430 approximately along the same direction. Therefore, the side light leakage is avoided, and the brightness of the light-emitting component 100 is effectively enhanced.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A light beam controlling member configured to cover an optical component, wherein the optical component is configured to generate light, the light beam controlling member comprising:
a body having a symmetrical optical axis, a bottom surface, a light entering surface, and a light exiting surface, wherein the bottom surface is connected to the light entering surface and the light exiting surface, and the light exiting surface is on an outer side of the body, and the light enter surface is located on an inner side of the body, and the light entering surface defines a cavity for accommodating the optical component, and the light entering surface is divided into a first light entering region and a second light entering region, and the first light entering includes is a concave surface, and the second light entering region is connected to the first light entering region and the bottom surface, and the second light entering region is an inwardly inclined surface.

2. The light beam controlling member of claim 1, wherein the symmetric optical axis intersects a virtual surface extending from the bottom surface of the body at a reference point, and a first line connecting the reference point to any point of the light entering surface has a first length, and a first angle is formed between the first line and the symmetrical optical axis, and the grater the first angle is, the smaller the first length is.

3. The light beam controlling member of claim 1, wherein the light exiting surface is convex, and the symmetric optical axis intersects a virtual surface extending from the bottom surface of the body at a reference point, and a second line connecting the reference point to any point of the light exiting surface has a second length, and a second angle is formed between the second line and the symmetrical optical axis, and the greater the second angle is, the greater the second length is.

4. The light beam controlling member of claim 1, wherein a third angle is formed between the second light entering region and the bottom surface, and the third angle is smaller than 90°.

5. The light beam controlling member of claim 4, wherein the third angle is in a range from about 40° to about 50°.

6. The light beam controlling member of claim 4, wherein the third angle is about 45°.

7. The light beam controlling member of claim 1, wherein the second light entering region is divided into a first light entering sub-region and a second light entering sub-region, and the first light entering sub-region is a smooth surface, and the second light entering sub-region is a sandblasted matte structure.

8. The light-emitting component, comprising:
a substrate having a top surface used as a reflective surface;
an optical component disposed on the substrate, wherein the optical component generates light; and
the light beam controlling member of claim 1 disposed on the substrate.

9. The light-emitting component of claim 8, wherein the top surface is a white paint reflective surface.

10. The light-emitting component of claim 8, wherein the top surface is divided into a central part and a peripheral part, and the optical component is disposed on the central part, and the bottom surface is at least partially disposed on the peripheral part, and the central part is a white paint layer, and the peripheral part is a metal reflective surface.
